(19) United States
(12) Patent Application Publication
(10) Pub. No.: US 2002/0076309 A1
(43) Pub. Date: Jun. 20, 2002

(54) Chock for restricting movement of an object

(76) Inventor: Clarence Duggins, Brandenburg, KY (US)

Correspondence Address: KING & SCHICKLI, PLLC, 247 NORTH BROADWAY, LEXINGTON, KY, 40507, US

(21) Appl. No.: 09/947,335

(22) Filed: Sep. 5, 2001

Related U.S. Application Data
(60) Provisional application No. 60/230,543, filed on Sep. 5, 2000.

(51) Int. Cl. B65F 9/00

(52) U.S. Cl. 414/401

(57) ABSTRACT

A chock is provided for use in a transportation container having one or more support rails. The chock includes an integral body having a rail-engaging member for cooperatively engaging one of the rails and a receiver portion adapted for receiving a portion of an object, such as the wheel of a wheeled vehicle or a corner of another large object. The chock of the present invention includes a rail-engaging tab extending laterally from the body of the chock, thereby allowing the user to fix the chock in place from the side of the object being restrained.

This application claims the benefit of the filing date of U.S. Provisional Patent Application Ser. No. 60/230,543, filed Sep. 5, 2000.

### TECHNICAL FIELD

The present invention relates in general to a chock for restricting the movement of an object relative to a support structure. The invention relates more particularly to a chock that may be easily mounted or removed from a support rail in a transport container.

### BACKGROUND OF THE INVENTION

Chocks for restricting the movement of objects are known. More particularly, it is known to utilize some means of restraint for restricting the movement of crates or wheeled vehicles being transported within a transport container, e.g. a moving van or railroad car. Prior restraint means often require a tie down system to fasten the object to the container. Other restraint means known in the art include a chock that requires access to the front of the object during installation. This requires increased time and labor on the part of the installer. When, for example, the object is positioned such that its front is in close proximity to a wall of the transport container, the installer must have full access to the front of the object. When the object is a vehicle, this often necessitates crawling under the vehicle, which increases the required labor. Accordingly, there is a need in the art for a chock suitable for use on objects, such as wheeled vehicles or crates, being transported in a transport container that is simple to install, even when access to the front or rear of the object is partially or totally obstructed.

### SUMMARY OF THE INVENTION

The chock of the present invention is constructed to restrain the movement of an object, such as a wheeled vehicle or other large object, being transported, such as in a transport container, e.g. a moving van, a railroad car, a shipboard container, and the like. The chock is constructed to be used in a container or like support structure already adapted to receive support rails. The use of such rails for restricting motion of items placed therein, or as support frames for constructing false floors, such as in moving vans, is known in the art. The chock of the present invention includes an integral body constructed of a material of suitable strength for reliably supporting the adjacent object, such as steel, aluminum, or even in some cases plastic polymers. The chock incorporates a means for cooperatively engaging the support rail extending along the floor of a transport container and includes a receiver portion adapted for receiving a portion of an object, such as the wheel of a wheeled vehicle.

In one aspect, the present invention provides an improved chock suitable for restraining movement of objects being transported.

In another aspect, the present invention provides a chock suitable for use in a transport container for restraining movement of objects, such as wheeled vehicles, which reduces time and effort required to secure the object in place in the chock.

In still another aspect, the present invention provides a chock that may be easily attached to and removed from a preexisting rail.

In yet still another aspect, the present invention provides a chock for restraining movement of objects being transported such as wheeled vehicles, which may be affixed to a preexisting rail without requiring access to the front, rear, or underside of the object being secured.

Additional objects, advantages and other novel features of the invention will be set forth in part in the description that follows and in part will become apparent to those skilled in the art upon examination of the foregoing, or may be learned with the practice of the invention.

### BRIEF DESCRIPTION OF THE DRAWING

The accompanying drawings incorporated in and forming a part of the specification illustrate several aspects of the present invention and, together with the description, serve to explain the principles of the invention. In the drawings:

FIG. 1 is a perspective view showing the chock of the present invention.

FIG. 2 is a top view showing the rail engaging tab.

FIG. 3 is a top view showing the ground-engaging member.

FIG. 4 illustrates use of a presently preferred embodiment of the invention to restrain a wheeled vehicle.

### DETAILED DESCRIPTION OF THE INVENTION

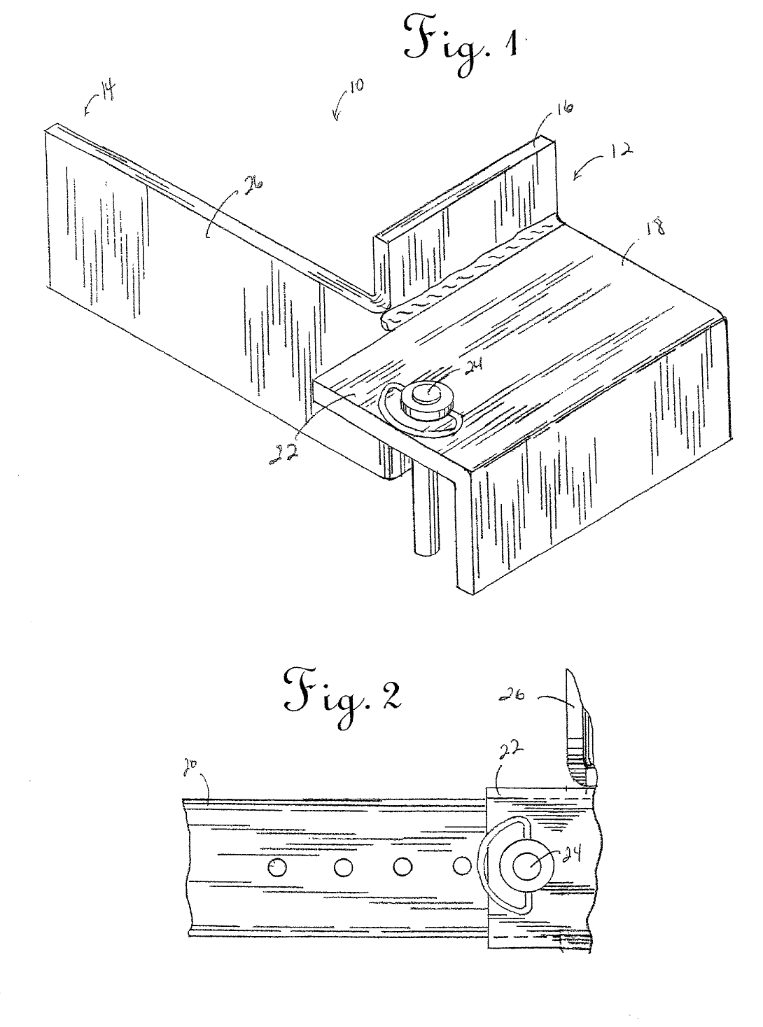

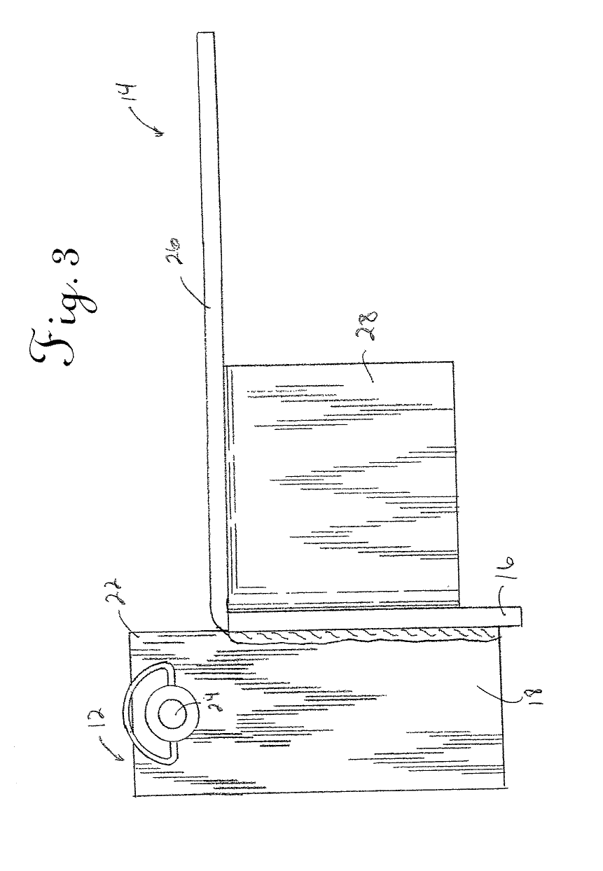

Referring to FIGS. 1-4, the chock 10 of the present invention is composed of a retaining member 12 and an engaging member 14. Retaining member 12 comprises a vertical plate 16 having a top side, a bottom side, a left side, and a right side. Retaining member 12 further comprises an L-shaped plate 18 extending horizontally from the top side of vertical plate 16, and adapted to receive a rectangular rail 20 of a type commonly known in the art. L-shaped plate 18 extends laterally beyond the side of vertical plate 16, forming a rail engaging tab 22. In a most preferred embodiment, rail-engaging tab 22 is provided with an aperture that, when placed in proximity to one of a plurality of corresponding apertures in rail 20, serves to secure the chock 10 to rail 20. In this most preferred embodiment, chock 10 is secured to rail 20 by a pin 24 passing through these aligned apertures. However, the aperture may also be positioned in any other portion of the plate 18, as long as the pin 24 is capable of engaging the corresponding rail 20.

The engaging member 14 extends from vertical plate 16 in the opposite direction from retaining member 12 and serves as a retention device. Engaging member 14 comprises a plate 26 extending perpendicularly from either the right or left side of vertical plate 16 and is designed to be placed flat against a side surface of an object, such as a vehicle wheel, to restrict lateral movement. It should be appreciated that plate 26 may extend from the right or left side of vertical plate 16, depending upon whether chock 10 is to be used to restrain a left or a right side of the object or wheeled vehicle being transported.

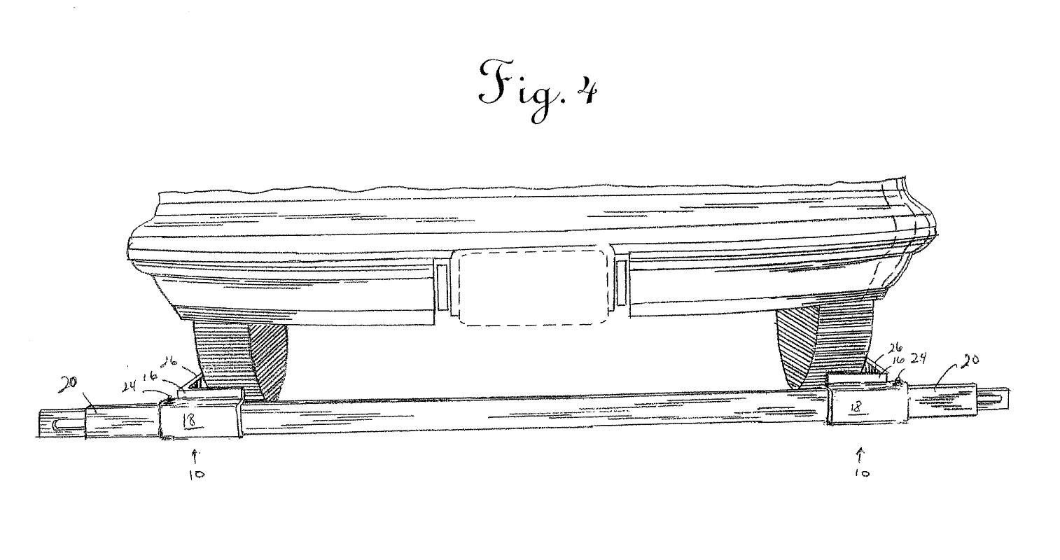

As can be appreciated from FIG. 3, the engaging member 14 further comprises a ground-engaging plate 28 extending perpendicularly from the bottom edge of vertical plate 16 and laterally from the bottom edge of plate 26. In this manner, rectangular plate 26, ground engaging plate 28 and vertical plate 16 cooperatively serve to restrict lateral and horizontal movement of a wheeled vehicle or other large object positioned thereon.

Reference is now made to FIG. 4 to illustrate use of a presently preferred embodiment of the present invention. At least one fixed rail 20 extends across a stable support surface, such as the interior floor surface of a vehicle transport container, e.g. a moving van or railroad car. It will be appreciated by those skilled in the art that rail 20 may be floor-engaging, or raised to any desired height. Such rail systems for use in transport containers are known in the art. Left and right chocks 10 are fastened to rail 20 as described above, such as by using a pin 24. When the object is wheeled, each chock 10 is positioned such that the rectangular plate 26 and the vertical plate 16 is in substantial contact with the outer and bottom surfaces of the corresponding wheel. It should be appreciated that rail-engaging tab 22 extending laterally from chock 10 obviates the need for accessing the front of a vehicle or other large object during installation, as pin 24 may be inserted into position from the side. Advantageously, this allows the placement of a chock 10 in the desired position to restrain an object without requiring physical access to the front of the object, such as when multiple objects are positioned in close proximity, or when an object to be secured is placed in close proximity to a wall of the transport container.

A second floor-engaging rail 20 may then be fixed in place at the rear of the object to be transported, again with the corresponding rail 20 extending laterally across the interior floor surface of the vehicle transport container. Preferably, left and right chocks 10 are positioned at the left and right rear of the object and affixed to rail 20 using pins 24. In this manner, both lateral and horizontal motion of the object is restrained during transport. Again, it should be appreciated that rail-engaging tab 22 extending laterally from chock 10 obviates the need for accessing the rear of a vehicle or other large object during installation, as pin 24 may be inserted into position from the side.

The foregoing description of a preferred embodiment of the invention has been presented for purposes of illustration and description. It is not intended to be exhaustive or to limit the invention to the precise form disclosed. Obvious modifications or variations are possible in light of the above teachings. For example, instead of using an L-shaped plate 18 to engage rail 20, a U-shaped channel (not shown) may be used instead. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention when interpreted in accordance with the breadth to which it is fairly, legally, and equitably entitled.

What is claimed is:

1. A chock assembly for restricting motion of an object relative to a stable support structure, comprising:
a rail extending transversely across a surface of said stable support structure;
a retaining member for engaging said rail; and
an engaging member for receiving or engaging a portion of said object.

2. The chock assembly of claim 1, wherein said retaining member comprises:
a vertical plate; and
a rail-engaging member for engaging said rail, said rail-engaging member extending horizontally from said vertical plate.

3. The chock assembly of claim 2, wherein said rail-engaging member is substantially L-shaped to nest with said rail.

4. The chock assembly of claim 2, wherein said rail-engaging member may be secured to said rail by a pin passing through at least one aperture in said rail-engaging member and at least one corresponding aperture in said rail.

5. The chock assembly of claim 2, wherein a projecting portion of said rail-engaging member is affixed to said vertical plate and said at least one aperture is located in said projecting portion.

6. The chock assembly of claim 1, wherein said engaging member comprises:
a first vertical plate;
a second vertical plate extending from said first vertical plate; and
a ground engaging member;
said first vertical plate, second vertical plate, and ground-engaging member cooperatively acting to restrict motion of the object when placed adjacent thereto.

7. The chock assembly of claim 6, wherein said second vertical plate extends from a right side of said first vertical plate.

8. The chock assembly of claim 6, wherein said second vertical plate extends from a left side of said first vertical plate.

9. The chock assembly of claim 6, wherein said ground-engaging member extends perpendicularly from a bottom side of said first vertical plate.

10. A method for restricting movement of an object having a front side, a rear side, a left side, and a right side, relative to a rail contained in a stable support structure, using the chock assembly of claim 1.

11. A method for restricting movement of an object having a front side, a rear side, a left side, and a right side, relative to a rail on a stable support structure, comprising the steps of:
placing said front side of said object in substantial proximity to said rail;
affixing at least one chock to said first rail and substantially in contact with one of said left or said right sides of said object;
wherein said at least one chock comprises:
a vertical plate having a top portion, a bottom portion, a left portion, and a right portion;
a rail-engaging member for engaging said rail extending horizontally from said top portion of said vertical plate in a first direction;
an engaging structure for engaging said object, said engaging structure extending horizontally from said vertical plate in a second direction opposite to said first direction, and comprising an object-engaging member extending from said left or said right portion of said vertical plate, and a ground-engaging member extending from said bottom side of said vertical plate.

12. The method of claim 11, comprising affixing a second rail including spaced apertures therethrough in substantial proximity to said rear side of said object; and
affixing at least one chock to said second rail and substantially in contact with said left and said right sides of said object;

13. The method of claim 11, wherein said rail-engaging member is substantially L-shaped to nest with said rail.

14. The method of claim 11, wherein said rail-engaging member may be secured to said rail by a pin passing through at least one aperture in said rail-engaging member and a corresponding one of said plurality of apertures in said rail.

15. The method of claim 11, wherein a portion of said rail-engaging member of said chock extends laterally beyond said vertical plate, allowing engagement of said chock with said rail from an exposed one of said sides of said object.

16. The method of claim 11, wherein said object is a wheeled vehicle.

17. A chock assembly for restricting motion of an object relative to a stable support structure, comprising:
a rail extending across a surface of said stable support structure;
means for engaging said rail; and
means for receiving or engaging a portion of said object.
